(19) United States
(12) Patent Application Publication
(10) Pub. No.: US 2023/0276109 A1
(43) Pub. Date: Aug. 31, 2023

(54) CURATING NON-FUNGIBLE TOKEN COLLECTIONS IN RELATION TO AUDIOVISUAL CONTENT

(71) Applicant: Source Digital, Inc., Barto, PA (US)

(72) Inventors: Kevin Sanborn, Philadelphia, PA (US); Nicholas Steele, Levittown, PA (US); Michael E. Phillips, Melrose, MA (US); Henry L. Frecon, III, Barto, PA (US)

(21) Appl. No.: 17/652,589

(22) Filed: Feb. 25, 2022

(51) Int. Cl. H04N 21/81; H04N 21/858; H04N 21/43; H04N 21/439; G06F 21/10

(52) U.S. Cl. CPC H04N 21/8133; H04N 21/858; H04N 21/43074; H04N 21/4394; G06F 21/10; G06F 2221/0713

(57) ABSTRACT

Curating non-fungible token collections to be presented to audience members of an audiovisual program content may include communicating synchronization data derived from an audiovisual content such that subsequent alignment of the synchronization data to the audiovisual content activates non-fungible tokens correlated to the audiovisual content during playout of respective time periods of the audiovisual content. Curating non-fungible token collections to be presented to audience members of an audiovisual program content may also include minting a portion of the audiovisual content into a newly minted non-fungible token incorporating previously existing non-fungible tokens correlated to the portion of the audiovisual content.

### BACKGROUND

Audiovisual content such as TV shows, movies, sport events, etc. is produced, processed, and transmitted to consumers. In addition to traditional media distribution channels such as broadcast television, cable, etc., the proliferation of electronic communication technologies has allowed for mass delivery of audiovisual content to consumers. Newer forms of distribution channels include streaming video, video sharing websites, video games, virtual and augmented reality environments, peer-to-peer environments, etc.

More recently, non-fungible tokens have also proliferated. A non-fungible token is a unique and non-interchangeable unit of data or metadata stored on a digital ledger (i.e., blockchain). Non-fungible tokens can be associated with reproducible digital files such as photos, videos, and audio. In some cases, a non-fungible token can point to a physical object that is part of the purchased token with a one-to-one relationship to the number available for purchase. Non-fungible tokens use a digital ledger to provide a public certificate of authenticity or proof of ownership, but it does not restrict the sharing or copying of the underlying digital file. Non-fungible tokens are often kept in digital wallets from which the non-fungible tokens or their underlying digital file may be shared.

These technologies (non-tokenized audiovisual content and non-fungible tokens) have until now remained generally separate.

### SUMMARY OF THE INVENTION

Current technologies are deficient in deploying non-fungible tokens in relation to audiovisual content for consumption and enjoyment. Currently, there is no way to adequately and efficiently curate and distribute (i.e., sell, purchase, collect, share) non-fungible token collections relating to audiovisual content.

The present disclosure provides methods and systems to address these problems. The present disclosure discloses methods and systems for curating non-fungible token collections to be presented and potential distributed to audience members in the context of an audiovisual program content. The non-fungible tokens may be contextually related to the audiovisual program content but contextual relationship is not necessary. The methods and systems may activate non-fungible tokens at relevant times during playout of the audiovisual content, hence providing a potentially artistic outlet for presentation of non-fungible token collections. The methods and systems may also allow a user to mint portions of an audiovisual content into newly minted non-fungible tokens incorporating any previously existing non-fungible tokens already correlated to the audiovisual content. This allows for further creativity and potential compounding of the value of non-fungible token collections as well as expansion of the inventory of non-fungible tokens available to the marketplace.

The accompanying drawings, which are incorporated in and constitute a part of the specification, illustrate various example systems, methods, and so on, that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

### BRIEF DESCRIPTION OF THE DRAWINGS

FIG. 1 illustrates a schematic diagram of an exemplary method or system for presenting non-fungible tokens to audience members of an audiovisual program content.

FIG. 2 illustrates an exemplary graphical user interface (GUI) for curating non-fungible tokens to the audiovisual content of FIG. 1.

FIG. 3 illustrates a schematic diagram of an exemplary method or system for minting new non-fungible tokens relating to content and incorporating previously existing non-fungible tokens.

FIG. 4 illustrates a block diagram of an exemplary system for curating and minting non-fungible tokens to be presented to audience members of an audiovisual content.

FIG. 5 illustrates a flow diagram for an exemplary method for curating non-fungible tokens to be presented to audience members of an audiovisual content.

FIG. 6 illustrates a flow diagram for an exemplary method for minting non-fungible tokens to be presented to audience members of an audiovisual content.

FIG. 7 illustrates a block diagram of an exemplary machine for curating, presenting, and minting non-fungible tokens to be presented to audience members of an audiovisual content.

### DETAILED DESCRIPTION

### Novel NFT Wallet

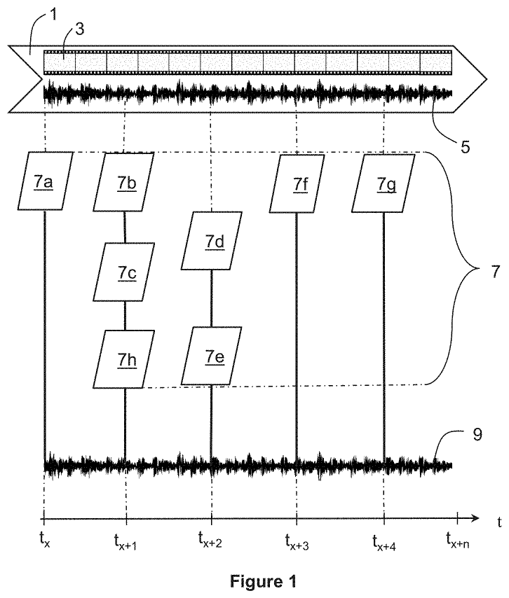

FIG. 1 illustrates a schematic diagram of an exemplary method or system for presenting non-fungible tokens to audience members of an audiovisual program content. FIG. 1 shows an audiovisual content 1, which includes a visual portion 3 and an audio portion 5. The audiovisual content 1 may be a movie, a TV show, a sports event (e.g., basketball game), Internet video, a video game, a podcast, a virtual reality (VR), augmented reality (AR), or mixed reality (MR) environment content, etc.

FIG. 1 also shows non-fungible tokens 7. A user may select non-fungible tokens (e.g., by clicking or touching the display on which the content (and/or the non-fungible token) is displayed) to interact with the non-fungible tokens 7. The user may also interact with the non-fungible tokens 7 by speaking (e.g., voice recognition) or even thinking (e.g., brain-computer interface (BCI)) about interactions with the content 1 and/or non-fungible tokens 7.

The system of FIG. 1 may present non-fungible tokens 7 synchronized to the content 1. Some methods of synchronization of non-fungible tokens 7 to audiovisual content 1 may require an explicit data connection between the content's source and the target or consumer. This explicit timing data may communicate the timing of activation of the non-fungible tokens 7 relative to the content 1 (e.g., a scene, a character or athlete appearing on screen, a sports highlight, etc.) to equipment at the consumer premises. Other methods of synchronization may rely on metadata attached to the content 1 to communicate the timing of activation of the non-fungible tokens 7 relative to the content 1. For example, non-fungible tokens 7 may be activated, unlocked, or otherwise made available to a user based on metadata in the content 1 timeline or reaching a specific moment or series of moments in the content 1, or based on a combination of metadata and timeline.

In the example of FIG. 1, three non-fungible tokens 7b, 7c, 7h correlate to time tₓ₊₁ in the content 1 timeline. In one embodiment, non-fungible token 7b (but not non-fungible tokens 7c, 7h) may be activated, unlocked, or otherwise made available to a user based, in addition to one or more of metadata in the content 1, timeline, etc., on a comparison of the non-fungible tokens 7b, 7c, 7h to the user's existing non-fungible tokens library. A selection algorithm can make the comparison to the user's existing non-fungible tokens library and select non-fungible tokens to activate based on the comparison. This way, more relevant non-fungible tokens may be presented to the user.

FIG. 1 illustrates a representation 9 of the audio portion 5 of the audiovisual content 1 in the form of an audio waveform signature. The representation 9 matches the audio portion 5 of the audiovisual content 1, at least to the extent that the audio portion 5 is identifiable from the representation 9 at any point along the time t. In the embodiment of FIG. 1, the non-fungible tokens 7 are each correlated to the representation 9 at instants of the representation 9 corresponding to instants of the audio portion 5 of the content 1. In this manner, the non-fungible tokens 7 may each be correlated to instants of the content 1.

In one embodiment, the non-fungible tokens 7 may be correlated to a duration or time period (and not merely one instant) on the content 1. In such embodiment, the non-fungible tokens 7 may be correlated to two (or more) instants on the content 1 representing a start and an end, respectively, of the duration on the content 1 (e.g., a whole movie scene, the whole length of time a character or athlete appears on screen, a whole game sequence, etc.) In another embodiment, the non-fungible tokens 7 may be correlated to a start instant and a duration on the content 1 applicable to the non-fungible token 7. In such embodiment, the non-fungible tokens 7 may be correlated to the starting (or ending) instant on the content 1 representing a start (or an end), respectively, of the duration on the content 1 (e.g., a movie scene) and the duration specified as an absolute term.

In the example of FIG. 1, non-fungible token 7a is correlated to the instant of representation 9 corresponding to time tₓ of the audiovisual content 1. Non-fungible tokens 7b, 7c, and 7h are correlated to the instant of representation 9 corresponding to time tₓ₊₁ of the audiovisual content 1. Non-fungible tokens 7d and 7e are correlated to the instant of representation 9 corresponding to time tₓ₊₂. Non-fungible token 7f is correlated to the instant of representation 9 corresponding to time tₓ₊₃ of the audiovisual content 1 and non-fungible tokens 7g is correlated to the instant of representation 9 corresponding to time tₓ₊₄ of the audiovisual content 1. Data identifying each of the non-fungible tokens 7 and the representation 9 may then be stored in a database that may be made accessible to future users or viewers of the audiovisual content 1. This way, when the audiovisual content 1 is distributed to those users or viewers, the representation 9 as well as the non-fungible tokens 7 correlated to the representation 9 may be available to those users or viewers.

At the user's premises, the audio portion 5 of the audiovisual content 1 being received may be compared real-time to the representation 9 to identify the audiovisual content 1 and to synchronize the audio portion 5 and hence the audiovisual content 1 to the representation 9. Moreover, since the non-fungible tokens 7 are correlated to the instants of the representation 9 corresponding to their respective times of the audiovisual content 1, the non-fungible tokens 7 may be synchronized to the audiovisual content 1, even in the absence of explicit timing and video container offset data.

Although in the embodiment of FIG. 1 the content's audio is used to synchronize the non-fungible tokens 7 to the content 1, the present invention is not so limited. The non-fungible tokens 7 may be synchronized to the content 1 as otherwise described herein and/or as known in the art.

In practice, a user who collects non-fungible tokens may keep or present her collection of non-fungible tokens in a curated form, the non-fungible tokens appearing along a piece of content at relevant times. A user may for example, present her collection of sports-related non-fungible tokens appearing along a sports event at moments relevant to the specific non-fungible tokens. Similarly, a user may present her collection of movie-related non-fungible tokens appearing along that movie at moments relevant to the specific non-fungible tokens. For example, a Dwayne “The Rock” Johnson non-fungible token may appear during a Furious 7 scene in which the actor appears. In a more complex example, a collection of non-fungible tokens including DSS Hobbs (Dwayne Johnson), Dom (Vin Diesel), Brian (Paul Walker), Letty (Michelle Rodriguez), Roman (Tyrese Gibson), Deckard Shaw (Jason Statham), Owen Shaw (Luke Evans) may be presented during respective scenes in which each of these characters (actors) appear by themselves or together, as shown in FIG. 1.

Content navigation may be derived via non-fungible tokens. For example, a user may query for specific non-fungible tokens or more specifically for portions of the content 1 to which specific non-fungible tokens 7 are correlated (e.g., “take me to a Vin Diesel NFT in this movie.”)

It is important here to note that the content 1 itself may correspond to a non-fungible token and, thus, the non-fungible tokens 7 may be correlated to a duration or time period of a main non-fungible token, the content 1. In such a case, the non-fungible tokens 7 may enhance or extend the user experience beyond that of the main non-fungible token (the content 1) alone. This process of nesting non-fungible tokens into non-fungible tokens as described herein may be carried out theoretically infinitely, providing users with immense possibilities as to how to curate a non-fungible token library or collection.

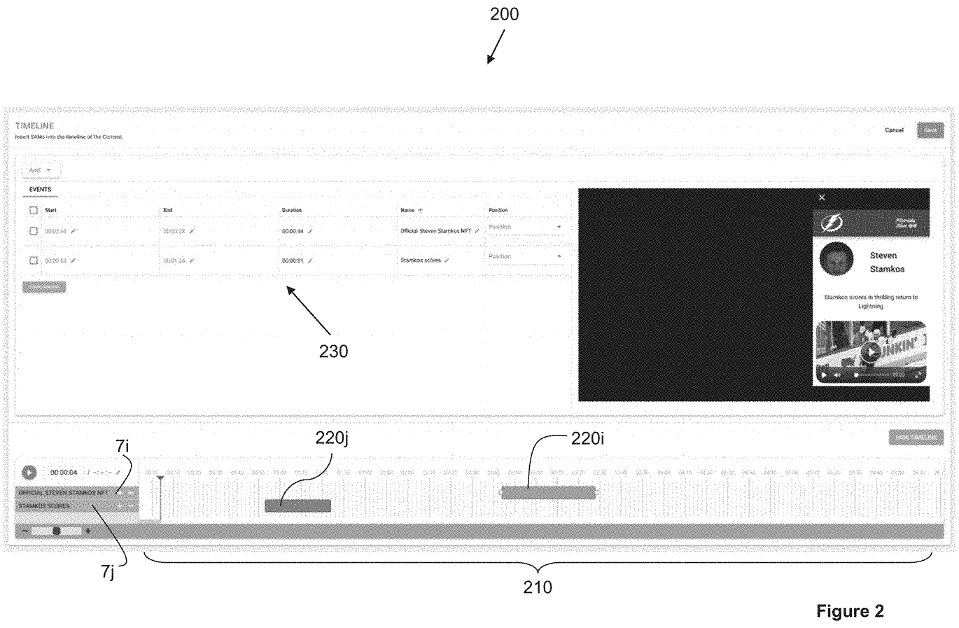

FIG. 2 illustrates an exemplary screen shot of a user interface 200 for curation and presentation of non-fungible token collections to an audience of a visual program content. The content 1 in the example of FIG. 2 is a hockey game involving the Tampa Bay Lightning of the National Hockey League. Specifically, the content 1 is a 6 minutes, 15 seconds portion of that hockey game. Using the interface 200, a user may synchronize activation of non-fungible tokens 7i and 7j to respective time periods of the audiovisual content 1.

In the example of FIG. 2, non-fungible token 7i is an official Steven Stamkos non-fungible token. That is, the non-fungible token 7i was obtained from an organization (e.g., NHL) that makes available official non-fungible tokens (e.g., of its teams, players, etc.) The non-fungible token 7j corresponds to a video clip of a game sequence in which Steven Stamkos (Tampa Bay's center and captain) scores a goal. The non-fungible token 7j may be a newly minted non-fungible token as described below. The user may use the interface 200 and specifically the timeline 210 to specify the time period in which each of the non-fungible tokens 7i and 7j are to be presented or correlated to. In the example of FIG. 2, the user places an elongates a time ribbon 220i to select the time period from 2:44 to 3:28 for the non-fungible token 7i (Official Steven Stamkos NFT) to be presented or correlated to. Similarly, the user places an elongates a time ribbon 220j to select the time period from 0:53 to 1:24 for the non-fungible token 7j (Stamkos Scores) to be presented or correlated to.

In the alternative, the user may use the portion 230 of the user interface 200 to select non-fungible tokens and specific start, end, or duration times of the content 1 for the non-fungible tokens to be presented. The user may also select a specific position (top, bottom, right, left, center, etc.) of the content 1 for the non-fungible tokens to be presented. In this additional way, the user may synchronize activation of non-fungible tokens 7i and 7j to respective time periods of the audiovisual content 1.

The non-fungible tokens 7i and 7j now correlated to the respective time periods, a subsequent alignment of the synchronization data to the audiovisual content 1 activates the non-fungible tokens 7i and 7j during playout of the respective time periods of the audiovisual content 1. That is, an audience member (e.g., the user herself or anybody else playing the audiovisual content 1) may playout the audiovisual content 1 and, during the respective time periods, the non-fungible tokens 7i and 7j will be activated to be presented to the audience member in synchronicity with the audiovisual content 1.

In the example of FIG. 1, three non-fungible tokens 7b, 7c, 7h correlate to time tₓ₊₁ in the audiovisual content 1. In one embodiment, non-fungible token 7b (but not non-fungible tokens 7c, 7h) may be activated, unlocked, or otherwise presented to the audience member in synchronicity with the audiovisual content 1 based on a comparison of the non-fungible tokens 7b, 7c, 7h to the user's existing non-fungible tokens library or other rules relating to the content or the user. For example, a selection algorithm can make the comparison to the user's existing non-fungible tokens library and select non-fungible tokens to activate based on the comparison. This way, more relevant non-fungible tokens may be presented to the user. In another example, the selection algorithm may consider environmental rules (e.g., user's age, gender, geographical location, time of day, day of year, season, weather, temperature, recent events, etc.) in selecting which, when, or how (e.g., location on the screen, orientation, duration, etc.) a non-fungible token is presented to a user.

FIGS. 1 and 2 illustrate the audiovisual content 1 as a traditional two-dimensional example (e.g., a two-dimensional TV show, movie, or hockey game) but the systems and methods disclosed herein are not limited to two dimensional content and may work just as well for curating non-fungible token collections in relation to three-dimensional content (e.g., 3D video games, 3D movies, 3D virtual, etc.), augmented or mixed reality, etc. Such three-dimensional content has similar portions and periods to which non-fungible tokens may be correlated following the techniques disclosed herein. Moreover, portions of periods of three-dimensional content may be minted as newly minted non-fungible tokens incorporating existing non-fungible tokens as disclosed below.

### Novel NFT Minter

In one embodiment, the user may mint a portion of the audiovisual content 1 into a newly minted non-fungible token incorporating previously existing non-fungible tokens. For example, during playout of the above-described hockey game involving the Tampa Bay Lightning of the National Hockey League (in this example, the audiovisual content 1), the user may mint a particular sequence of the game in which Steven Stamkos scores (in this example, the 6 minutes, 15 seconds sequence in which Steven Stamkos scores a goal).

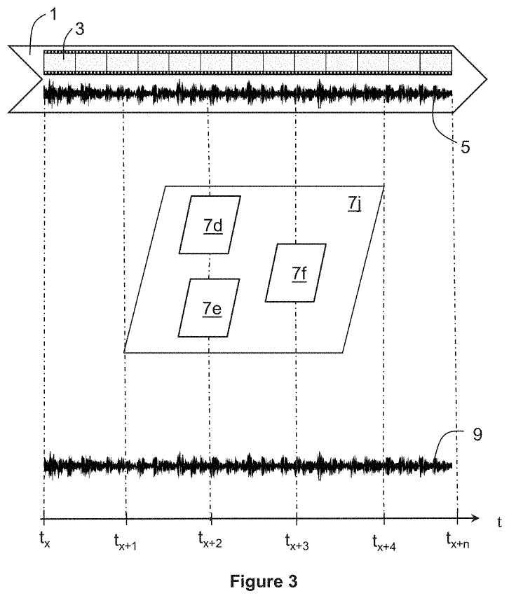

FIG. 3 schematically illustrates this embodiment. FIG. 3 shows an audiovisual content 1 (e.g., a Tampa Bay Lightning game), which includes a visual portion 3 (e.g., video of the game) and an audio portion 5 (e.g., play-by-play, etc.) As described above, a user may have previously curated so that the non-fungible tokens 7d, 7e, and 7f activate at selected times or time periods of the content 1 (e.g., non-fungible tokens 7d and 7e at a time period centered at tₓ₊₂ and non-fungible token 7f at a time period centered at tₓ₊₃.)

FIG. 3 also illustrates a representation 9 of the audio portion 5 of the audiovisual content 1 in the form of an audio waveform signature. The representation 9 matches the audio portion 5 of the audiovisual content 1 at least to the extent that the audio portion 5 is identifiable from the representation 9 along the time t. The non-fungible tokens 7d, 7e, and 7f are each correlated to the representation 9 at time periods of the representation 9 corresponding to the time periods of the audio portion 5 to which the non-fungible tokens 7d, 7e, and 7f are correlated. In this manner, the non-fungible tokens 7d, 7e, and 7f are each correlated to the time periods of the audiovisual content 1.

During a playout of the audiovisual content 1, the audio portion 5 of the audiovisual content 1 being received may be compared real-time to the representation 9 to synchronize the audio portion 5 and hence the audiovisual content 1 to the representation 9. Moreover, since the non-fungible tokens 7d, 7e, and 7f are correlated to the instants of the representation 9 corresponding to their respective time periods of the audiovisual content 1, the non-fungible tokens 7d, 7e, and 7f are synchronized to the audiovisual content 1, even in the absence of explicit timing data. Although in the embodiment of FIG. 3 the content's audio is used to synchronize the non-fungible tokens 7 to the content 1, the present invention is not so limited. The non-fungible tokens 7 may be synchronized to the content 1 as otherwise described herein and/or as known in the art.

During such playout of the content 1, a user (same user or anybody watching the previously curated content) may mint non-fungible token 7j. So, for example, if the audiovisual content 1 corresponds to a hockey game, the portion from tₓ₊₁ to tₓ₊₄ may correspond to the action sequence in which Steven Stamkos scores. The user may use the inventive system of the present disclosure to mint a video clip of the time portion from tₓ₊₁ to tₓ₊₄ as a newly minted non-fungible token 7j that incorporates the previously minted non-fungible tokens 7d, 7e, and 7f.

The same user or other users can continue this process theoretically ad-infinitum with further newly minted non-fungible tokens incorporating previously minted non-fungible tokens. Because of the structure of the system as described above, the newly minted non-fungible tokens would similarly be synchronized to activate during playout of the relevant portion of the audiovisual content including activation of the previously existing non-fungible tokens.

This system allows for progressive and derivative creation of non-fungible tokens and collections, enhancing the environment and promoting creativity and interaction. Users may build on each other's creations, enhancing artistic and potential monetary value.

In one embodiment, prior to minting of a new non-fungible token 7j the user may be able to observe that previously minted non-fungible tokens 7d, 7e, and 7f are correlated/synchronized to the audiovisual content 1 and more specifically correlated/synchronized to a specific portion of the audiovisual content 1. This way the user may decide whether to mint a non-fungible token and specifically what portion of the content 1 to mint into a non-fungible token at least in part based on the any previously minted non-fungible tokens correlated/synchronized to the audiovisual content 1 and more specifically correlated/synchronized to the specific portion of the audiovisual content 1.

The nature of non-fungible token technology, for example, according to the ERC-721 standard (https://eips.ethereum.org/EIPS/eip-721) is such that the history and ownership of each non-fungible token in the potentially vast chain of embedded non-fungible tokens may be made readily recordable and available. The ERC-721 standard is an inheritable solidity smart contract standard, meaning that new ERC-721-compliant contracts may be created for such embedded non-fungible tokens as described herein. ERC-721 provides core methods that allow tracking ownership of non-fungible tokens, as well as a permissioned way for owners to transfer assets to others. This information may be made readily available in, for example, the OpenZeppelin library. This makes analysis of history, ownership, and, importantly, determination of any royalties due to non-fungible token owners readily achievable.

Although ERC-721 is disclosed herein as an example of an inheritable solidity smart contract standard, analysis of history, ownership, and determination of royalties due to non-fungible token owners is achievable using other standard and non-standard techniques. It should be understood then that, beyond the example of ERC 721, the present invention is capable of working in conjunction with the larger ecosystem of blockchains and smart contract technology and, thus, the present invention supports all smart contract enabled blockchains and even cross-chain or para-chain interoperability.

Transactionally, minting of new non-fungible tokens incorporating previously existing non-fungible tokens as described herein may make use of sidechains such as, for example, Ethereum layer 2 that reduces or eliminates gas fees that would otherwise accrue if the transactions were to take place on the layer 1 blockchain. In fact, the invention disclosed herein may itself operate as a sidechain or a full blockchain designed to operate as a sidechain or layer 2 with all other blockchains.

In one embodiment, whenever a non-fungible token is newly minted, as described above, an automatic content recognition (ACR) hash uniquely identifying the newly created non-fungible token may be stored in the blockchain. The ACR hash may serve to later uniquely identify the non-fungible token. For example, a SHA-2 or better 256-bit hash may be created at the time of minting and stored in the blockchain. Because such hash is unique, it may be later used to uniquely identify the non-fungible token.

### System

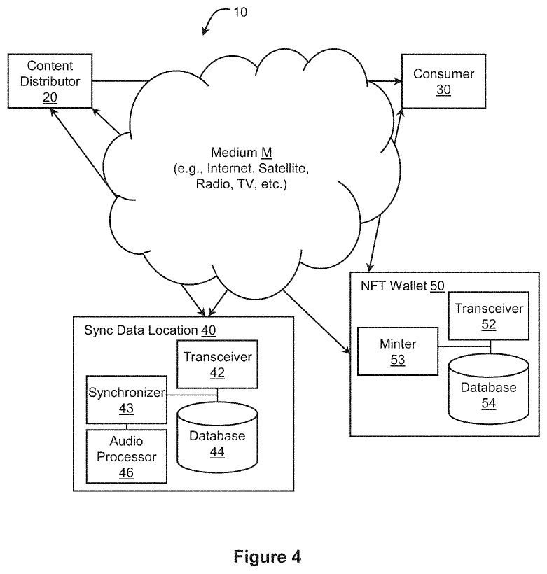

FIG. 4 illustrates a block diagram of an exemplary system 10 for curating, presenting, and minting non-fungible tokens to be presented to audience members of the content 1. The system 10 includes four major components: the content distributor 20, the consumer 30, the synchronization data location 40, and the NFT wallet 50. FIG. 4 also shows the medium M through which the content distributor 20, the consumer 30, the synchronization data location 40, and the NFT wallet 50 communicate with each other.

The content distributor 20 may include but is not limited to broadcasters or broadcasting facilities or equipment. In practice, the content distributor 20 may represent any facility or equipment that is part of or used in preproduction, production, postproduction, quality control, mastering equipment, broadcasting of any type (including professional or social media broadcasting), or other method of sending and distributing audio visual content, that touches the audiovisual content 1 prior to and during playout for transmission or broadcasting including stream content providers (e.g., YouTube®, Netflix®, etc.), a consumer's own devices such as a DVR, natural language processing devices (e.g., Amazon's Echo), etc. In automated or programmatic examples, the content distributor 20 may represent artificial intelligence (AI) driven media, AI content creators, and other expressions of computer-generated creation and/or dissemination of content.

Similarly, although for ease of explanation the present disclosure refers to the element 30 as the consumer 30, the element 30 is not limited to consumers or consumer premises or equipment. In practice, the consumer 30 may represent any premise or equipment that touches the audiovisual content 1 during or post playout for transmission, broadcasting, etc.

Regarding the synchronization data location 40 the synchronization data 9 may be stored in a database 44 that may be made accessible to future users or viewers of the audiovisual content 1. This way, when the audiovisual content 1 is later distributed to those users or viewers, the synchronization data 9 may be available to those users or viewers for use at the same time as the audiovisual content 1 for proper synchronization as described above such that the non-fungible tokens 7 may appear or activate aligned in time to the audiovisual content 1.

Because the content 1 itself may correspond to a non-fungible token and, thus, the non-fungible tokens 7 may be correlated to a duration or time period of a main non-fungible token (the content 1), the synchronization data 9 may be derived from a non-fungible token. In such a case, the non-fungible tokens 7 may enhance or extend the user experience beyond that of the main non-fungible token (the content 1) alone. This process of nesting non-fungible tokens into non-fungible tokens as described herein may be carried out theoretically infinitely and multi-directionally. For example, a user may use a non-fungible token in her collection as the content 1 and, using the synchronization data 9, may correlate non-fungible tokens in her own collection or non-fungible tokens belonging to others to be activated or unlocked at selected or relevant times. In another example, a user may use a non-fungible token in her collection as a non-fungible token 7 and, using the synchronization data 9, may correlate her non-fungible token to a main non-fungible token (i.e., the content 1) from her own collection or belonging to others such that her non-fungible token 7 may be activated or unlocked at selected or relevant times in the main non-fungible token (i.e., the content 1) from her own collection or belonging to others.

Regarding the NFT wallet 50 and authorship or collection of non-fungible tokens 7, non-fungible tokens 7 may be obtained, collected, or minted prior to playout, broadcast, distribution, or performance of the audiovisual content 1. For example, non-fungible tokens 7 may be obtained, collected, or minted during preproduction, production, post-production, quality control, or mastering of the audiovisual content 1. Non-fungible tokens 7 may also be obtained, collected, or minted during playout, broadcast, distribution, or performance of the audiovisual content 1. For example, if the audiovisual content 1 is a TV show, non-fungible tokens 7 may be obtained, collected, or minted during a first or subsequent broadcast of the TV show or personal playout of a recording of the TV show.

Regarding storage and distribution, non-fungible tokens 7 collected may be stored in a database 54 that may be made accessible to future users or viewers of the audiovisual content 1. This way, when the audiovisual content 1 is later distributed to those users or viewers, the non-fungible tokens 7 may be available to those users or viewers for consumption at the same time as the audiovisual content 1 or any portion of the audiovisual content 1 via any distribution medium 1. Although in the illustrated embodiment, the NFT wallet 50 is shown as a single wallet, the non-fungible tokens 7 may be minted or stored at different locations (e.g., non-fungible token 7i may be stored in one location owned or controlled by the user while non-fungible token 7j may be stored in another location owned or controlled by the content provider), preferably, although not necessarily, widely available to audiences.

Also, the medium M may be any medium used to transmit content 1 or data generally such as, for example, the Internet, satellite communication, radio communication, television communication (broadcast or cable), etc. Although in the figures the medium M is shown as being shared by the content distributor 20, the consumer 30, the ancillary data location 40, and the NFT wallet 50, communication between these elements does not need to take place in the same medium. So, for example, the content distributor 20 may communicate with the consumer 30 via satellite while the synchronization data location 40 and the NFT wallet 50 may communicate to consumer 30 via the Internet.

In the example of FIG. 4, the content distributor 20 transmits the audiovisual content 1 to the consumer 30. The consumer 30 receives the audiovisual content 1 from the content distributor 20, the synchronization data 9 from the synchronization data location 40, and the non-fungible tokens 7 from the NFT wallet 50.

The synchronization data location 40 may include a machine or group of machines for curating collections and presenting non-fungible tokens 7 correlated to the content 1. The synchronization data location 40 may include a transceiver 42 that communicates (i.e., transmits and receives) the content 1 and/or the non-fungible tokens 7 (or data identifying the non-fungible tokens 7) and a synchronizer 43 that correlates the non-fungible tokens 7 to the content 1 as described above. The synchronization data location 40 may also include the database 44 that stores the synchronization data 9 and data identifying the non-fungible tokens 7 correlated to the synchronization data 9.

The synchronization data location 40 may be a location accessible to the content distributor 20, the consumer 30, and the NFT wallet 50 such as the cloud or a local archive with general accessibility (e.g., via a link as described above) that may be controlled by subscription, password, etc.

The NFT wallet 50 may include a machine or group of machines including the database 54 that stores at least some of the non-fungible tokens 7. The NFT wallet 50 may also include a minter 53 for minting new non-fungible tokens. So, for example, the NFT wallet 50 may include a minter 53 that receives the content 1 from the content distributor 20 or the consumer 30. A user at consumer 30 may activate the minter 53 to mint portions of the content 1 into new non-fungible tokens according to ERC-721 (https://eips.ethereum.org/EIPS/eip-721) or equivalent. The NFT wallet 50 may also include a transceiver 52 that communicates (i.e., transmits and receives) the content 1 and the non-fungible tokens 7 or data identifying the non-fungible tokens 7 to other elements of the system 10.

The NFT wallet 50 may be a location accessible to the content distributor 20, the consumer 30, and the synchronization data location 40 such as the cloud or a local archive with general accessibility (e.g., via a link as described above) that may be controlled by subscription, password, etc.

At the consumer 30, the system 10 may access and use the synchronization data to activate the newly minted non-fungible token 7j during playout of the portion of the audiovisual content 1 including activation of the previously existing non-fungible tokens 7d, 7e, and 7f correlated to the corresponding portion of the audiovisual content 1.

In summary, the system 10 may include a synchronizer 43 that obtains synchronization data 9 derived from an audiovisual content 1 and synchronizes activation of non-fungible tokens 7 to respective time periods of the audiovisual content 1 based on the synchronization data 9. The system 10 may also include a transceiver 42 that communicates the synchronization data 9 such that subsequent alignment of the synchronization data 9 to the audiovisual content 1 at the consumer premises 30 activates the non-fungible tokens 7 during playout of the respective time periods of the audiovisual content 1.

In one embodiment, the synchronizer 43 collects data identifying the non-fungible tokens 7 (e.g., from the content wallet 50 or other sources) during a previous playout or performance of the audiovisual content 1 and correlates the data identifying the non-fungible tokens to the respective time periods of the audiovisual content. The transceiver 42 may communicate the synchronization data 9 and the data identifying the non-fungible tokens 7 correlated to the respective time periods of the audiovisual content 1 to the database 44 which is, in turn, accessible by consumers 30 of the audiovisual content 1. In one embodiment, the synchronizer 43 may create a link to the storage location 44 for distribution and later access of the synchronization data 9.

The system 10 may also include an audio processor 46 that creates the synchronization data 9 by, for example, extracting or creating a fingerprint from the audio or visual portion of the audiovisual content 1. The audio processor 46 may transmit the synchronization data 9 to the synchronizer 43 for synchronization as described above.

The system 10 may also include the minter 53 to mint portions of the audiovisual content 1 into newly minted non-fungible tokens. In this case, the synchronizer 43 may correlate all newly minted non-fungible tokens to respective portions of the synchronization data 9 corresponding to respective time periods of the audiovisual content 1 during which the minted portions of the audiovisual content 1 appear in the audiovisual content 1. A newly minted non-fungible token may incorporate previously existing non-fungible tokens correlated to or appearing during the portion of the audiovisual content 1 from which the newly minted non-fungible token was minted.

The system 10 may also include a non-fungible token database 54 that stores and makes available to users previously existing non-fungible tokens and newly minted non-fungible tokens. In one embodiment, one or more of the newly minted non-fungible tokens or their identifying information may be stored in, for example, the database 44, together with the synchronization data.

The system 10 may also use the synchronizer 43 and specifically the synchronization data to activate the newly minted non-fungible token 7j during playout of the portion of the audiovisual content 1 including activation of the previously existing non-fungible tokens 7d, 7e, and 7f correlated to the portion of the audiovisual content 1.

The system 10 may be implemented using software, hardware, analog or digital techniques.

A potential application of the systems and methods described herein include prefunding of content. Content creation and particularly creation of highly produced content such as motion pictures often requires raising significant amounts of capital. It is estimated that the average cost to produce, distribute, and market a major studio movie is currently around $100 million. Potential applications of the systems and methods described herein include prefunding of content (e.g., a motion picture) through sales of non-fungible tokens relevant to the content, be it whole scenes or frames minted into non-fungible tokens or non-fungible tokens otherwise activated in relation to the content, as described above. Because, as described above, royalties due to owners of the various non-fungible tokens nested into the content is trackable (e.g., via inheritable solidity smart contracts), purchasers of the non-fungible tokens may recover their investment based on revenue generated in the distribution of the content, the motion picture.

A contract may, for example, include the right to perform and/or share the non-fungible token (e.g., to play for oneself or for others a portion of the video corresponding to the scene or frame that constitutes the non-fungible token) or it may not allow it. A contract may, for example, include rights to the likeness of an actor appearing in the scene or frame that constitutes the non-fungible token for the purpose of playing or sharing the non-fungible token.

The systems and method disclosed herein may be used to facilitate the correlation between the non-fungible tokens and the content, as described above.

### Methods

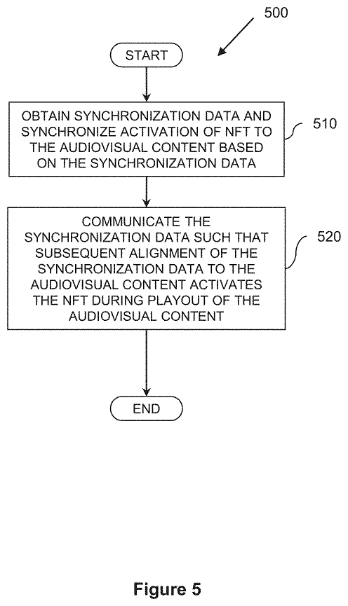

Exemplary methods may be better appreciated with reference to the flow diagram of FIGS. 4 and 5. While for purposes of simplicity of explanation, the illustrated methodologies are shown and described as a series of blocks, it is to be appreciated that the methodologies are not limited by the order of the blocks, as some blocks can occur in different orders or concurrently with other blocks from that shown and described. Moreover, less than all the illustrated blocks may be required to implement an exemplary methodology. Furthermore, additional methodologies, alternative methodologies, or both can employ additional blocks, not illustrated.

In the flow diagrams, blocks denote “processing blocks” that may be implemented with logic. The processing blocks may represent a method step or an apparatus element for performing the method step. The flow diagrams do not depict syntax for any particular programming language, methodology, or style (e.g., procedural, object-oriented). Rather, the flow diagrams illustrate functional information one skilled in the art may employ to develop logic to perform the illustrated processing. It will be appreciated that in some examples, program elements like temporary variables, routine loops, and so on, are not shown. It will be further appreciated that electronic and software applications may involve dynamic and flexible processes so that the illustrated blocks can be performed in other sequences that are different from those shown or that blocks may be combined or separated into multiple components. It will be appreciated that the processes may be implemented using various programming approaches like machine language, procedural, object oriented or artificial intelligence techniques.

FIG. 5 illustrates a flow diagram for an exemplary method 500 for curating non-fungible tokens to be presented to audience members of a visual program content. At 510, the method 500 may include obtaining synchronization data derived from an audiovisual content and synchronizing activation of non-fungible tokens to respective time periods of the audiovisual content based on the synchronization data. At 520, the method 500 may communicate the synchronization data such that subsequent alignment of the synchronization data to the audiovisual content activates the non-fungible tokens during playout of the respective time periods of the audiovisual content.

In one embodiment, the method 500 collects data identifying the non-fungible tokens during a previous playout or performance of the audiovisual content and correlates the data identifying the non-fungible tokens to the respective time periods of the audiovisual content.

In one embodiment, the method 500 communicates the synchronization data and data identifying the non-fungible tokens correlated to the respective time periods of the audiovisual content to a database accessible by consumers of the audiovisual content. The method 400 may further create a link to the storage location or database.

In one embodiment, the method 500 creates the synchronization data (e.g., from an audio portion or a visual portion of the audiovisual content), communicate the synchronization data and data identifying the non-fungible tokens correlated to the respective time periods of the audiovisual content to a storage location accessible by consumers of the audiovisual content, create a link to the storage location, and insert the link to the storage location into metadata. The method 500 may also transmit the synchronization data to a synchronizer for synchronization.

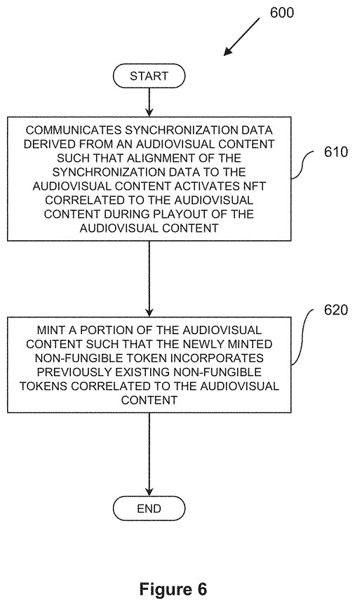

FIG. 6 illustrates a flow diagram for an exemplary method 600 for minting non-fungible tokens. At 610, the method 600 communicates (transmits and/or receives) synchronization data derived from an audiovisual content such that alignment of the synchronization data to the audiovisual content activates non-fungible tokens correlated to the audiovisual content during playout of respective time periods of the audiovisual content. At 620, the method 600 may mint a portion of the audiovisual content into a newly minted non-fungible token correlated to a respective portion of the synchronization data corresponding to a time period of the audiovisual content during which the portion of the audiovisual content appeared in the audiovisual content. The minting may be done such that the newly minted non-fungible token incorporates previously existing non-fungible tokens correlated to the one or more portions of the audiovisual content.

In one embodiment, the method 600 may correlate data identifying the newly minted non-fungible token to the respective portion of the synchronization data and hence the previously existing non-fungible tokens to the one or more portions of the audiovisual content.

In one embodiment, the method 600 may include using the synchronization data to activate the newly minted non-fungible token during playout of the portion of the audiovisual content including activation of the previously existing non-fungible tokens correlated to the portion of the audiovisual content.

In one embodiment, the method 600 may communicate (transmit and/or receive) the synchronization data and data identifying the newly minted non-fungible token correlated to the respective portion of the synchronization data to a storage location accessible by consumers of the audiovisual content.

While the figures illustrate various actions occurring in serial, it is to be appreciated that various actions illustrated could occur substantially in parallel, and while actions may be shown occurring in parallel, it is to be appreciated that these actions could occur substantially in series. While a number of processes are described in relation to the illustrated methods, it is to be appreciated that a greater or lesser number of processes could be employed, and that lightweight processes, regular processes, threads, and other approaches could be employed. It is to be appreciated that other exemplary methods may, in some cases, also include actions that occur substantially in parallel. The illustrated exemplary methods and other embodiments may operate in real-time, faster than real-time in a software or hardware or hybrid software/hardware implementation, or slower than real time in a software or hardware or hybrid software/hardware implementation.

### Machine

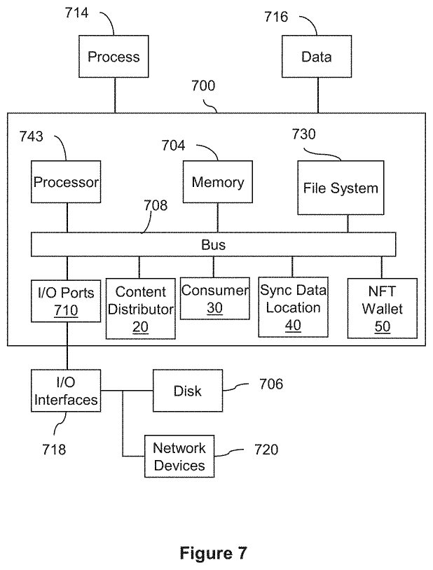

FIG. 7 illustrates a block diagram of an exemplary machine 700 for curating and/or presenting non-fungible tokens to be presented to audience members of a visual program content. The machine 700 includes a processor 743, a memory 704, and I/O Ports 710 operably connected by a bus 708.

In one example, the machine 700 may receive input signals including the audiovisual content 1, the visual portion 3, the audio portion 5, the non-fungible tokens 7, the representation 9, etc. via, for example, I/O Ports 710 or I/O Interfaces 718. The machine 700 may also include the transceiver 42, the synchronizer 43, the database 44, and the audio processor 46 of the sync data location 40 and the transceiver 52, minter 53, and database 54 of the NFT wallet 50. Thus, the content distributor 20, the consumer 30, the sync data location 40, and the NFT wallet 50 as disclose herein may be implemented in machine 700 as hardware, firmware, software, or a combination thereof and, thus, the machine 700 and its components may provide means for performing functions described and/or claimed herein as performed by the transceiver 42, the synchronizer 43, the database 44, or the audio processor 46 of the sync data location 40 and the transceiver 52, minter 53, or the database 54 of the NFT wallet 50.

The processor 743 can be a variety of various processors including dual microprocessor and other multi-processor architectures. The memory 704 can include volatile memory or non-volatile memory. The non-volatile memory can include, but is not limited to, ROM, PROM, EPROM, EEPROM, and the like. Volatile memory can include, for example, RAM, synchronous RAM (SRAM), dynamic RAM (DRAM), synchronous DRAM (SDRAM), double data rate SDRAM (DDR SDRAM), and direct RAM bus RAM (DRRAM).

A data store 706 may be operably connected to the machine 700 via, for example, an I/O Interfaces (e.g., card, device) 718 and an I/O Ports 710. The data store 706 can include, but is not limited to, devices like a magnetic disk drive, a solid-state disk drive, a floppy disk drive, a tape drive, a Zip drive, a flash memory card, or a memory stick. Furthermore, the data store 706 can include optical drives like a CD-ROM, a CD recordable drive (CD-R drive), a CD rewriteable drive (CD-RW drive), or a digital video ROM drive (DVD ROM). The data store 706 may also include cloud storage (e.g., AWS, etc.) The memory 704 can store processes 714 or data 716, for example. The data store 706 or memory 704 can store an operating system that controls and allocates resources of the machine 700.

The bus 708 can be a single internal bus interconnect architecture or other bus or mesh architectures. While a single bus is illustrated, it is to be appreciated that machine 700 may communicate with various devices, logics, and peripherals using other busses that are not illustrated (e.g., PCIE, SATA, Infiniband, 1394, USB, Ethernet). The bus 708 can be of a variety of types including, but not limited to, a memory bus or memory controller, a peripheral bus or external bus, a crossbar switch, or a local bus. The local bus can be of varieties including, but not limited to, an industrial standard architecture (ISA) bus, a microchannel architecture (MCA) bus, an extended ISA (EISA) bus, a peripheral component interconnect (PCI) bus, a universal serial (USB) bus, and a small computer systems interface (SCSI) bus.

The machine 700 may interact with input/output devices via I/O Interfaces 718 and I/O Ports 710. Input/output devices can include, but are not limited to, a keyboard, a microphone, a pointing and selection device, cameras, video cards, displays, data store 706, network devices 720, and the like. The I/O Ports 710 can include but are not limited to, serial ports, parallel ports, and USB ports.

The machine 700 can operate in a network environment and thus may be connected to network devices 720 via the I/O Interfaces 718, or the I/O Ports 710. Through the network devices 720, the machine 700 may interact with a network. Through the network, the machine 700 may be logically connected to remote computers. The networks with which the machine 700 may interact include, but are not limited to, a local area network (LAN), a wide area network (WAN), and other networks. The network devices 720 can connect to LAN technologies including, but not limited to, fiber distributed data interface (FDDI), copper distributed data interface (CDDI), Ethernet (IEEE 802.3), token ring (IEEE 802.5), wireless computer communication (IEEE 802.11), Bluetooth (IEEE 802.15.1), Zigbee (IEEE 802.15.4) and the like. Similarly, the network devices 720 can connect to WAN technologies including, but not limited to, point to point links, circuit switching networks like integrated services digital networks (ISDN), packet switching networks, and digital subscriber lines (DSL). While individual network types are described, it is to be appreciated that communications via, over, or through a network may include combinations and mixtures of communications.

### Definitions

The following includes definitions of selected terms employed herein. The definitions include various examples or forms of components that fall within the scope of a term and that may be used for implementation. The examples are not intended to be limiting. Both singular and plural forms of terms may be within the definitions.

“Content” corresponds to still images, segments of audio media, video media, or audio/visual (AV) media and include information that is embodied, stored, transmitted, received, processed, or otherwise used with at least one medium. Common media content formats include FLV format (flash video), Windows Media Video, RealMedia, MFX, Quicktime, MPEG, MP3, DivX, live stream formats such as RTMP, JPEGs, and Bitmaps. As used herein, the terms “media clips,” “media content,” “information content,” and “content” may be used interchangeably.

“Data store” or “database,” as used herein, refers to a physical or logical entity that can store data. A data store may be, for example, a database, a table, a file, a list, a queue, a heap, a memory, a register, and so on. A data store may reside in one logical or physical entity or may be distributed between two or more logical or physical entities.

“Logic,” as used herein, includes but is not limited to hardware, firmware, software, or combinations of each to perform a function(s) or an action(s), or to cause a function or action from another logic, method, or system. For example, based on a desired application or needs, logic may include a software-controlled microprocessor, discrete logic like an application specific integrated circuit (ASIC), a programmed logic device, a memory device containing instructions, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

An “operable connection,” or a connection by which entities are “operably connected,” is one in which signals, physical communications, or logical communications may be sent or received. Typically, an operable connection includes a physical interface, an electrical interface, or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical or physical communication channels can be used to create an operable connection.

In broadcasting, “playout” is a term for the transmission of radio or TV channels from the broadcaster into broadcast networks that delivers the content to the audience. In the context of this disclosure, streaming is a form of playout.

“Signal,” as used herein, includes but is not limited to one or more electrical or optical signals, analog or digital signals, data, one or more computer or processor instructions, messages, a bit or bit stream, or other means that can be received, transmitted, or detected.

“Software,” as used herein, includes but is not limited to, one or more computer or processor instructions that can be read, interpreted, compiled, or executed and that cause a computer, processor, or other electronic device to perform functions, actions or behave in a desired manner. The instructions may be embodied in various forms like routines, algorithms, modules, methods, threads, or programs including separate applications or code from dynamically or statically linked libraries. Software may also be implemented in a variety of executable or loadable forms including, but not limited to, a stand-alone program, a function call (local or remote), a servlet, an applet, instructions stored in a memory, part of an operating system or other types of executable instructions. It will be appreciated by one of ordinary skill in the art that the form of software may depend, for example, on requirements of a desired application, the environment in which it runs, or the desires of a designer/programmer or the like. It will also be appreciated that computer-readable or executable instructions can be located in one logic or distributed between two or more communicating, co-operating, or parallel processing logics and thus can be loaded or executed in serial, parallel, massively parallel, and other manners.

Suitable software for implementing the various components of the example systems and methods described herein may be produced using programming languages and tools like Java, Pascal, C #, C++, C, CGI, Perl, SQL, APIs, SDKs, assembly, firmware, microcode, or other languages and tools. Suitable software for implementing the various components of the example systems and methods described herein may be in addition be produced using other programming languages and tools such as JavaScript, GoLang, Rust or other modern languages. Software, whether an entire system or a component of a system, may be embodied as an article of manufacture and maintained or provided as part of a computer-readable medium as defined previously. Another form of the software may include signals that transmit program code of the software to a recipient over a network or other communication medium. Thus, in one example, a computer-readable medium has a form of signals that represent the software/firmware as it is downloaded from a web server to a user. In another example, the computer-readable medium has a form of the software/firmware as it is maintained on the web server. Other forms may also be used.

“User” or “consumer,” as used herein, includes but is not limited to one or more persons, software, computers or other devices, or combinations of these.

Some portions of the detailed descriptions that follow are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like processing, computing, calculating, determining, displaying, or the like, refer to actions and processes of a computer system, logic, processor, or similar electronic device that manipulates and transforms data represented as physical (electronic) quantities.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

While example systems, methods, and so on, have been illustrated by describing examples, and while the examples have been described in considerable detail, it is not the intention of the applicants to restrict or in any way limit scope to such detail. It is, of course, not possible to describe every conceivable combination of components or methodologies for purposes of describing the systems, methods, and so on, described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

What is claimed is:

1. A machine or group of machines, comprising:
a synchronizer configured to obtain synchronization data derived from an audiovisual content and to synchronize activation of non-fungible tokens to respective time periods of the audiovisual content based on the synchronization data; and
a transceiver configured to communicate the synchronization data such that subsequent alignment of the synchronization data to the audiovisual content activates the non-fungible tokens during playout of the respective time periods of the audiovisual content.

2. The machine or group of machines of claim 1, wherein:
the synchronizer is configured to collect data identifying the non-fungible tokens during a previous playout or performance of the audiovisual content and to correlate the data identifying the non-fungible tokens to the respective time periods of the audiovisual content.

3. The machine or group of machines of claim 1, wherein:
the transceiver is configured to communicate the synchronization data and data identifying the non-fungible tokens correlated to the respective time periods of the audiovisual content to a database accessible by consumers of the audiovisual content.

4. The machine or group of machines of claim 1, wherein:
the transceiver is configured to communicate the synchronization data and data identifying the non-fungible tokens correlated to the respective time periods of the audiovisual content to a storage location accessible by consumers of the audiovisual content; and
the synchronizer is configured to create a link to the storage location.

5. The machine or group of machines of claim 1, comprising:
an audio processor configured to create the synchronization data, wherein:
the transceiver is configured to communicate the synchronization data and data identifying the non-fungible tokens correlated to the respective time periods of the audiovisual content to a storage location accessible by consumers of the audiovisual content;
the synchronizer is configured to create a link to the storage location; and
the audio processor is configured to insert the link to the storage location into metadata.

6. The machine or group of machines of claim 1, comprising:
an audio processor configured to create the synchronization data and transmit the synchronization data to the synchronizer.

7. The machine or group of machines of claim 1, comprising:
an audio processor configured to derive the synchronization data from an audio portion or a visual portion of the audiovisual content.

8. The machine or group of machines of claim 1, comprising:
a minter configured to mint a portion of the audiovisual content into a newly minted non-fungible token, the synchronizer configured to correlate the newly minted non-fungible token to a respective portion of the synchronization data corresponding to a time period of the audiovisual content during which the portion of the audiovisual content appeared in the audiovisual content.

9. The machine or group of machines of claim 1, comprising:
a minter configured to mint one or more portions of the audiovisual content into a newly minted non-fungible token incorporating previously existing non-fungible tokens correlated to the one or more portions of the audiovisual content.

10. The machine or group of machines of claim 1, comprising:
a non-fungible token database configured to make available to users previously existing non-fungible tokens; and
a minter configured to mint a portion of the audiovisual content into a newly minted non-fungible token incorporating one or more of the previously existing non-fungible tokens.

11. The machine or group of machines of claim 1, comprising:
a minter configured to mint a portion of the audiovisual content into a newly minted non-fungible token incorporating previously existing non-fungible tokens correlated to the portion of the audiovisual content; and
the synchronizer or another synchronizer configured to use the synchronization data to activate the newly minted non-fungible token during playout of the portion of the audiovisual content including activation of the previously existing non-fungible tokens correlated to the portion of the audiovisual content.

12. A machine or group of machines, comprising:
a transceiver configured to communicate synchronization data derived from an audiovisual content such that subsequent alignment of the synchronization data to the audiovisual content activates non-fungible tokens correlated to the audiovisual content during playout of respective time periods of the audiovisual content.

13. The machine or group of machines of claim 12, comprising:
a minter configured to mint a portion of the audiovisual content into a newly minted non-fungible token; and
a synchronizer configured to correlate the newly minted non-fungible token to a respective portion of the synchronization data corresponding to a time period of the audiovisual content during which the portion of the audiovisual content appeared in the audiovisual content.

14. The machine or group of machines of claim 12, comprising:
a minter configured to mint one or more portions of the audiovisual content into a newly minted non-fungible token incorporating previously existing non-fungible tokens correlated to the one or more portions of the audiovisual content.

15. The machine or group of machines of claim 12, comprising:
a minter configured to mint a portion of the audiovisual content into a newly minted non-fungible token incorporating previously existing non-fungible tokens correlated to the portion of the audiovisual content; and
a synchronizer configured to use the synchronization data to activate the newly minted non-fungible token during playout of the portion of the audiovisual content including activation of the previously existing non-fungible tokens correlated to the portion of the audiovisual content.

16. A machine or group of machines, comprising:
a transceiver configured to communicate synchronization data derived from an audiovisual content such that alignment of the synchronization data to the audiovisual content activates non-fungible tokens correlated to the audiovisual content during playout of respective time periods of the audiovisual content; and
a minter configured to mint a portion of the audiovisual content into a newly minted non-fungible token correlated to a respective portion of the synchronization data corresponding to a time period of the audiovisual content during which the portion of the audiovisual content appeared in the audiovisual content.

17. The machine or group of machines of claim 16, comprising:
the minter configured to mint one or more portions of the audiovisual content into the newly minted non-fungible token such that the newly minted non-fungible token incorporates previously existing non-fungible tokens correlated to the one or more portions of the audiovisual content.

18. The machine or group of machines of claim 16, comprising:
the minter configured to mint one or more portions of the audiovisual content into the newly minted non-fungible token such that the newly minted non-fungible token incorporates previously existing non-fungible tokens correlated to the one or more portions of the audiovisual content; and
a synchronizer configured to use the synchronization data to activate the newly minted non-fungible token during playout of the portion of the audiovisual content including activation of the previously existing non-fungible tokens correlated to the portion of the audiovisual content.

19. The machine or group of machines of claim 16, comprising:
the minter configured to mint one or more portions of the audiovisual content into the newly minted non-fungible token such that the newly minted non-fungible token incorporates previously existing non-fungible tokens correlated to the one or more portions of the audiovisual content; and
a synchronizer configured to correlate data identifying the newly minted non-fungible token to the respective portion of the synchronization data and hence the previously existing non-fungible tokens to the one or more portions of the audiovisual content.

20. The machine or group of machines of claim 16, comprising:
the minter configured to mint one or more portions of the audiovisual content into the newly minted non-fungible token such that the newly minted non-fungible token incorporates previously existing non-fungible tokens correlated to the one or more portions of the audiovisual content;
a synchronizer configured to correlate data identifying the newly minted non-fungible token to the respective portion of the synchronization data and hence the previously existing non-fungible tokens to the one or more portions of the audiovisual content; and
the transceiver configured to communicate the synchronization data and data identifying the newly minted non-fungible token correlated to the respective portion of the synchronization data to a storage location accessible by consumers of the audiovisual content.
